(19) United States
(12) Patent Application Publication
(10) Pub. No.: US 2018/0241555 A1
(43) Pub. Date: Aug. 23, 2018

(54) LOW POWER WIDE AREA MODULE PERFORMING ENCRYPTED COMMUNICATIONS AND METHOD THEREOF

(71) Applicant: Samsung Electro-Mechanics Co., Ltd., Suwon-si (KR)

(72) Inventors: Byong Hyok CHOI, Suwon-si (KR); Chul Wan PARK, Suwon-si (KR); Se Houn LEE, Suwon-si (KR)

(73) Assignee: Samsung Electro-Mechanics Co., Ltd., Suwon-si (KR)

(21) Appl. No.: 15/854,351

(22) Filed: Dec. 26, 2017

(30) Foreign Application Priority Data
Feb. 20, 2017 (KR) 10-2017-0022550

(51) Int. Cl. H04L 9/08; H04W 12/04; H04L 29/06

(52) U.S. Cl. CPC H04L 9/0861; H04W 12/04; H04W 84/18; H04L 63/0428; H04L 63/18; H04L 63/067

(57) ABSTRACT

A low power wide area (LPWA) apparatus includes an LPWA module configured to perform first encrypted communications using a gateway and a session key, generate a secret key to perform a second encrypted communications with an application device, transmit the secret key encrypted using a public key to the application device, and transmit encrypted data based on the secret key to the application device and receive data from the application device.

### CROSS-REFERENCE TO RELATED APPLICATION

This application claims benefits under 35 USC 119(a) of Korean Patent Application No. 10-2017-0022550 filed on Feb. 20, 2017 in the Korean Intellectual Property Office, the entire disclosures of which are incorporated herein by reference for all purposes.

### BACKGROUND

### 1. Field

The following description relates to a low power wide area (LPWA) module performing encrypted communications and a method thereof.

### 2. Description of Related Art

Demand for Internet of Things (IoT) services to monitor and control equipment, asset tracking, environmental sensing, and other applications in various fields, has increased. In order to provide such IoT services, a low power wide area (LPWA) module technology, differentiated from a conventional local area wireless communications technology or mobile communications technology, has come to prominence.

Low power wide area (LPWA) module technology performs long distance communications in contrast with local area wireless communications. LPWA module technology has low costs and less power consumption compared to long term evolution (LTE) communications.

In a low power wide area system, application devices, such as a metering device, a tracking device, and a sensor device transmit data to a LPWA module, and the LPWA module provides the data to a server through a gateway.

The application devices and the LPWA module are included in a single apparatus, and transmit and receive the data in wired communications. For example, the data is read data of electricity, water, and gas, and when the data is fabricated or forged, the server receives the forged read data.

In order to solve such a problem, an encryption method configured to prevent data forgery of the data that the LPWA module receives from the application devices is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a low power wide area (LPWA) module configured to perform encrypted communications and a method thereof.

In accordance with an embodiment, there may be provided a low power wide area (LPWA) apparatus, including: an LPWA module configured to perform first encrypted communications using a gateway and a session key, generate a secret key to perform a second encrypted communications with an application device, transmit the secret key encrypted using a public key to the application device, and transmit encrypted data based on the secret key to the application device and receive data from the application device.

The LPWA module may be further configured to transmit the secret key to the application device after receiving a call message transmitted by the application device.

The LPWA module has a private key to decode an encrypted call message.

The LPWA module may be further configured to perform encryption using an advanced encryption standard (AES) encryption algorithm.

The LPWA module and the application device may be connected through a wired communication channel.

In accordance with an embodiment, there may be provided a method of a low power wide area (LPWA) module, including: generating a secret key; transmitting the secret key encrypted using a public key to an application device; and transmitting encrypted data based on the secret key to the application device.

The transmitting of the secret key may be performed after the LPWA module receives a call message from the application device.

The transmitting of the secret key may be performed after the LPWA module decodes an encrypted call message using a private key.

The method may also include: performing a random number generation to obtain the secret key as a value.

The encrypted data may be encrypted based on the secret key using an advanced encryption standard (AES) encryption algorithm.

The public key and the secret key may include a size of 128 bits.

The method may also include: performing first encrypted communications using a gateway and a session key; and generating the secret key to perform a second encrypted communications with the application device.

The LPWA module and the application device may be connected through a wired communication channel.

In accordance with an embodiment, there may be provided a non-transitory computer-readable storage medium storing instructions that, when executed by a processor, cause the processor to perform the method described above.

Other features and aspects will be apparent from the following detailed description, the drawings, and the claims.

### BRIEF DESCRIPTION OF DRAWINGS

FIG. 1 is a diagram illustrating a communications system including a low power wide area (LPWA) module, according to an embodiment; and

FIG. 2 is a flowchart of communications between the LPWA module and an application module, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

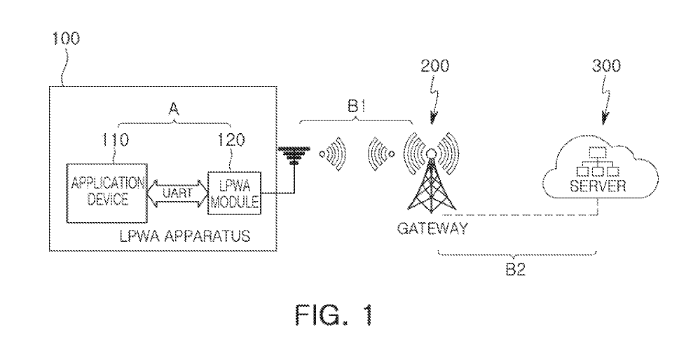

FIG. 1 is a diagram illustrating a communications system including a low power wide area (LPWA) module, according to an embodiment.

Referring to FIG. 1, a network of a communications system includes a LPWA apparatus 100, a gateway 200, and a server 300. Further, the network may include a plurality of LPWA apparatuses 100.

The LPWA apparatus 100 includes an application device 110 and an LPWA module 120.

Accordingly, in an example, the application device 110 and the LPWA module 120 are implemented using one or more processor or controllers.

The application device 110 is a metering apparatus, a tracking apparatus including GPS, and a sensor apparatus, and includes processor circuits such as microcontrollers, microprocessors, and application specific integrated circuits (ASICs). Alternatively, the application device 110 is controlled by the processor circuit included in the LPWA module 120. Further, the application device 110 is connected to the LPWA module 120 wirelessly or hard wired. For example, the application device 110 and the LPWA module 120 communicate with each other in a universal asynchronous receiver/transmitter (UART) manner or a universal serial bus (USB) manner.

The LWPA module 120 receives data from the application device 110 and outputs the data to the server 300 through the gateway 200. Further, the server 300 transmits the data to the LPWA apparatus 100 through the gateway 200. That is, in a communications system, the data is transmitted in two directions of an uplink direction from the LPWA apparatus 100 to the server 300 and a downlink direction from the server 300 to the LPWA apparatus 100.

In addition, the communications system associated with such an LPWA module is implemented by a standard communications type such as SIGFOX, or LoRa (Long Range) using a non-licensed frequency band. SIGFOX is based on an ultra-narrow band (UNB) and LoRa may be based on IEEE 802.15.4g.

Further, communications B1 between the LPWA module 120 and the gateway 200 and communications B2 between the gateway 200 and the server 300 are encrypted and performed using a session key, an encrypted key temporarily used only for one communications session. That is, the LPWA module 120 decodes the data transmitted from the gateway 200 and encrypts the data transmitted from the application device 110 using the session key, and transmits the decoded and encrypted data to the gateway 200.

Further, communications A between the LPWA module 120 and the application device 110 are encrypted and performed using a secret key generated by the LPWA module 120.

For instance, the LPWA module 120 generates the secret key at the time of starting of an operation through an application of power, or from an operation by a user. Further, the secret key may be a value obtained through a random number generation.

Further, the LPWA module 120 transmits the secret key to the application device 110 and transmits and receives the data to and from the application device 110 in a symmetric key manner using the secret key.

For example, the LPWA module 120 and the application device 110 encrypt and decode the data using an advanced encryption standard (AES) encryption algorithm.

The AES encryption algorithm, one of symmetric block cipher manners which are efficient in encrypting mass data, is defined in Federal Information Processing Standards (FIPS) 197. Examples of subblock conversion processing defined in FIPS 197 include AddRoundKey, SubBytes, ShiftRows, MixColumns, InvSubBytes, InvShiftRows, and InvMixColumns. Further, a round function repeated for the encryption and decoding may include four processes of SubBytes, ShiftRows, MixColumns, and AddRoundKey for the encryption and include four processes of InvShiftRows, InvSubBytes, AddRoundKey, and InvMixColumns for the decoding. In an example in which a size of the key for the encryption in AES is 128 bits, it may be referred to as AES-128 and the round function is repeated ten times. According to an embodiment, a public key and a secret key for the encryption and the decoding may be 128 bits in size.

Furthermore, in order to prevent an external device from obtaining the secret key, the secret key transmitted from the LPWA module 120 is encrypted. To this end, the LPWA module 120 encrypts the secret key using the public key and transmits the encrypted secret key to the application device 110. The LPWA module may 120 pre-possess or pre-store the public key.

Before the LPWA module 120 transmits the encrypted secret key, the LPWA module 120 receives a call message from the application device 110. Once receiving the call message, the LPWA module 120 transmits the secret key at a point of time at which the application device 110 waits for reception of the secret key.

However, the call message operated by the external device other than the application device 10 is transmitted. Thus, once the external device receives the encrypted secret key from the LPWA module 120, the external device transmits data to the LPWA module 120.

Also, the call message is encrypted to prevent an advance transmission of the data from the external device. To this end, the application device 110 encrypts the call message using the public key and transmits the encrypted call message to the LPWA module 120. Further, the application device 110 may pre-possess the public key.

In addition, the LPWA module 120 and the application device 110 transmit and receive the call message and the secret key in a symmetric key manner in which the public key is used as an encryption key and a decoding key. For example, the application device 110 encrypts and transmits the call message using a first public key and the LPWA module 120 decodes the encrypted call message using the first public key. Further, the LPWA module 120 encrypts and transmits the secret key using a second public key and the application device 110 decodes the secret key using the second public key.

Further, the LPWA module 120 and the application device 110 may pre-possess the first public key and the second public key, and the first public key may be the same public key as the second public key.

Further, the LPWA module 120 and the application device 110 may transmit and receive the call message and the secret key in a non-symmetric manner, in which the encryption key and the decoding key are different from each other.

In an example, the application device 110 encrypts and transmits the call message using the first public key and the LPWA module 120 decodes the encrypted call message using a first private key corresponding to the first public key. Further, the LPWA module 120 encrypts and transmits the secret key using the second public key and the application device 110 decodes the secret key using a second private key corresponding to the second public key.

In an example, the application device 110 pre-possesses the first public key and the second private key, or receives the second private key from the LPWA module 120. Also, the LPWA module 120 pre-possesses the second public key and the first private key, or receives the first private key from the application device 110.

Further, the first public key and the second public key may be the same public key, and the first private key and the second private key may be the same private key.

As such, according to an embodiment, because the LPWA module 120 is enabled to perform encrypted wireless communications with the gateway 200 and encrypted wired communications with the application device 110 is provided, the LPWA system including the LPWA module 120 effectively ensures integrity of the data.

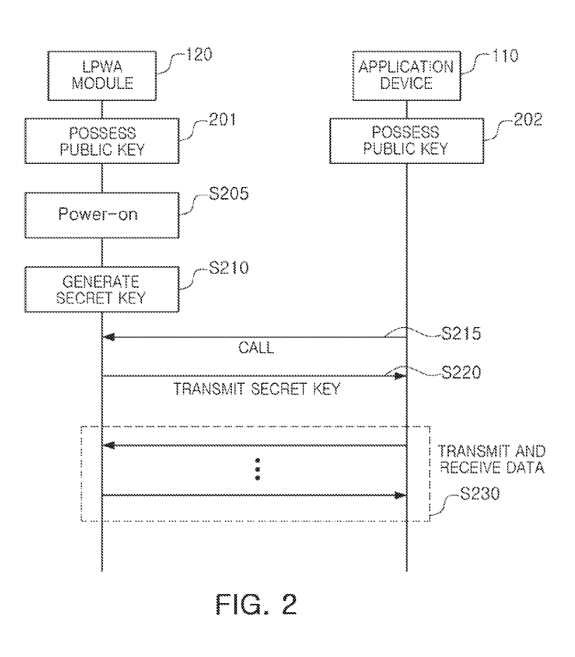

FIG. 2 is a flowchart of communications between the LPWA module and an application module, according to an embodiment.

Referring to FIGS. 1 and 2, the LPWA module 120 possesses or pre-stores the public key of the LPWA module (201) and the application device 110 possesses or pre-stores the public key of the application device (202).

At operation S205, the LPWA module 120 is powered on, and generates the secret key immediately after the being powered on. Encrypted communications between the LPWA module and the application device, according to an embodiment, begin at operation S210 in response to the LPWA module 120 generating the secret key.

At operation S220, the LPWA module 120 transmits the secret key encrypted by the public key to the application device 110. Further, before the LPWA module 120 transmits the secret key, the LPWA module 120 receives the message from the application device 110 and transmits the secret key as a response for the reception of the call message to the application device 110. In an example, the call message is encrypted and transmitted by the application device 110 and the LPWA module 120 receives and decodes the encrypted call message. Further, the LPWA module 120 uses the private key corresponding to the public key used to encrypt the call message to decode the encrypted call message.

At operation S230, the LPWA module 120 transmits and receives the data encrypted by the secret key to and from the application device 110.

As set forth above, according to various embodiments, the LPWA module performing the encrypted communications and the method thereof provide, at least, the encrypted communications protocol having high security in the wired communications with the application devices.

Further, security is further improved by providing the encrypted communications protocol in which the symmetrical key manner and the secret key manner are combined with each other.

The LPWA apparatus 100, the application device 110, and the LPWA module 120 in FIG. 1 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 2 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A low power wide area (LPWA) apparatus, comprising:
an LPWA module configured to
perform first encrypted communications using a gateway and a session key,
generate a secret key to perform a second encrypted communications with an application device,
transmit the secret key encrypted using a public key to the application device, and
transmit encrypted data based on the secret key to the application device and receive data from the application device.

2. The LPWA module of claim 1, wherein the LPWA module is further configured to transmit the secret key to the application device after receiving a call message transmitted by the application device.

3. The LPWA module of claim 2, wherein the LPWA module has a private key to decode an encrypted call message.

4. The LPWA module of claim 1, wherein the LPWA module is further configured to perform encryption using an advanced encryption standard (AES) encryption algorithm.

5. The LPWA module of claim 1, wherein the LPWA module and the application device are connected through a wired communication channel.

6. A method of a low power wide area (LPWA) module, comprising:
generating a secret key;
transmitting the secret key encrypted using a public key to an application device; and
transmitting encrypted data based on the secret key to the application device.

7. The method of claim 6, wherein the transmitting of the secret key is performed after the LPWA module receives a call message from the application device.

8. The method of claim 7, wherein the transmitting of the secret key is performed after the LPWA module decodes an encrypted call message using a private key.

9. The method of claim 6, further comprising:
performing a random number generation to obtain the secret key as a value.

10. The method of claim 6, wherein the encrypted data is encrypted based on the secret key using an advanced encryption standard (AES) encryption algorithm.

11. The method of claim 6, wherein the public key and the secret key comprise a size of 128 bits.

12. The method of claim 6, further comprising:
performing first encrypted communications using a gateway and a session key; and
generating the secret key to perform a second encrypted communications with the application device.

13. The method of claim 6, wherein the LPWA module and the application device are connected through a wired communication channel.

14. A non-transitory computer-readable storage medium storing instructions that, when executed by a processor, cause the processor to perform the method of claim 6.
